(19) United States
(12) Patent Application Publication
(10) Pub. No.: US 2025/0158818 A1
(43) Pub. Date: May 15, 2025

(54) SYSTEM AND METHOD FOR IMPLEMENTING EFFICIENT PRIVATE IDENTITY

(71) Applicant: Michael Pollard, Rockville, MD (US)

(72) Inventor: Michael Pollard, Rockville, MD (US)

(21) Appl. No.: 18/506,257

(22) Filed: Nov. 10, 2023

(51) Int. Cl. H04L 9/32

(52) U.S. Cl. CPC H04L 9/32

(57) ABSTRACT

A private identity system is configured to invoke an embedding layer that constructs encoded embeddings from plaintext identification inputs using pre-trained models. Identification inputs can be captured (e.g., biometric, face image, retinal scan, fingerprint, voice, health data, behavioral, etc.) in plaintext versions and transformed into encoded embeddings. The embeddings can be produced to be homomorphic one-way encryptions of the plaintext identification instances. According to some embodiments, the encoded embeddings can be used to identify an entity. The encoded embeddings can be stored in a vector database during enrollment, retrieved by querying the vector database during prediction, and used to establish a match to an identifier, identity, and/or entity. In further embodiments, vector indexes can be used to speed queries executed on the vector database, and achieve improved computation, reduced query speed, and improved identification latency relative to multiple AI model architectures (e.g., embedding and classifier architectures).

### BACKGROUND

Securing identification and authentication processes is a known challenge in every computing environment. Although user identifiers and password combinations are ubiquitous, their use is far from secure. Even methodologies that seek to augment known ID and passwords systems (e.g., multi-factor authentication, using additional codes, etc.) have failed to fully address security concerns. Various approaches also include machine learning algorithms in an attempt to further secure identity.

### SUMMARY

Even approaches that invoke multiple AI models that have shown initial promise can be subject to collisions (e.g., false positives) during enrollment. This problem is exacerbated when scaling the number of enrolled users. The inventors have realized that various security conscious approaches may also sacrifice performance to achieve security objectives, and still be subject to false positive issues. Further realized is that there remains a need for a security system (e.g., identification and/or authentication system) that provides for the use of encoded identity information and does so while minimizing computational burden and limiting collisions when enrolling users, relative to some multiple AI model architectures. According to some embodiments, the system is configured to invoke an embedding layer that is configured to construct encoded embeddings from plaintext identification inputs using pre-trained models. For example, biometric inputs can be captured (e.g., face image, retinal scan, fingerprint, voice, health data, etc.) in plaintext versions and transformed via pre-trained neural networks into encoded embeddings. The embeddings can be produced by the pre-trained neural networks as homomorphic one-way encryptions of plaintext identification instances.

According to some embodiments, the encoded embeddings can be used to identify an entity. In various embodiments, the encoded embeddings are stored in a vector database during enrollment, retrieved by querying the vector database, and used to establish a match to an identifier, identity, and/or entity. In further embodiments, vector indexes can be used to speed queries executed on the vector database, and achieve improved computation, reduced query speed, and improved identification latency relative to multiple AI model architectures (e.g., embedding and classifier architectures). In further embodiments, a centroid can be computed on enrollment embeddings for an entity and the centroid stored in the vector database for enrolled entities. Searching or query execution can be run against the stored centroid values and/or can be executed with vector indexes.

Such approaches also provide privacy in using and operating on encoded versions of identifying information that is linked to an identifier, a person, and/or entity. Although vector databases and vector indexes can be used to reduce the computational burden of initial identification, in some instances the results returned from these sources are over inclusive. Various embodiments are configured to incorporate additional review of query outputs from queries on the vector database to resolve any precision deficiency. In some examples, vector databases and/or vector indexes achieve efficiency by transforming vector data (e.g., embeddings) into a lower dimension space. The balance is that the transformations can be lossy, approximate, etc., which enables efficiency but reduces precision. Various embodiments leverage the efficiency gains and resolve issues raised by precisions trade-offs.

According to one aspect, a private identity system is provided. The system comprises at least one processor operatively connected to a memory, the at least one processor configured to instantiate at least one pre-trained embedding network configured to generate encrypted feature vectors from an input of plaintext identifying information, process an input of plaintext identifying information using the at least one pre-trained embedding network, generate a target encrypted feature vector for enrollment, and store a representation of the respective encrypted feature vector in a vector database or vector index for subsequent prediction.

According to one embodiment, the at least one processor is configured to validate submission of the plaintext identifying information. According to one embodiment, the at least one processor is configured to validate data captured in the plaintext identifying information (e.g., filtering bad identification instances, validating good instances). According to one embodiment, the at least one processor is configured to pre-process the data captured in the plaintext identifying information (e.g., generate cropped, aligned, and bounded face). According to one embodiment, the at least one processor is configured to store the target encrypted feature vector. According to one embodiment, the at least one processor is configured to associate an identifier with the representation of the respective encrypted feature vector. According to one embodiment, the representation of the respective encrypted feature vector is a lower dimension representation of the respective encrypted feature vector or the respective encrypted feature vector.

According to one embodiment, the representation of the respective encrypted feature vector is a centroid value computed from a set of encrypted feature vectors associated with an entity. According to one embodiment, the at least one processor is configured to: generate a prediction encrypted feature vector for prediction from an input of plaintext identifying information; and query the vector database or vector index to match in a first pass on a respective centroid value. According to one embodiment, the at least one processor is configured to return at least one similar representation of a plurality of encrypted feature vectors stored in the vector database or vector index. According to one embodiment, the at least one processor is configured to retrieve a plurality of respective encrypted feature vectors associated with the plurality of identifiers. According to one embodiment, the at least one processor is configured to compare the plurality of respective encrypted feature vectors to the prediction encrypted feature vector to determine a best match or verify a match.

According to one embodiment, the at least one processor is configured to generate a centroid value for a plurality of encrypted feature vectors associated with an entity; and store the centroid value in a vector database or vector index for subsequent prediction. According to one aspect, a private identity system, the system comprising at least one processor operatively connected to a memory, the at least one processor configured to instantiate at least one pre-trained embedding network configured to generate encrypted feature vectors from an input of plaintext identifying information, generate a target encrypted feature vector from an input of plaintext identifying information, (e.g., during enrollment or prediction) instantiate at least one vector database or vector index configured to process a query on a representation of the target encrypted feature vector and to identify similar representations of respective encrypted feature vectors where present and to identify an unknown result where no threshold similarity matches are returned during prediction, store a representation of the target encrypted feature vector during enrollment, construct an index on a plurality of representations of encrypted feature vectors in storage for query processing, retrieve an identifier based on the output of the similar lower dimension representations of the respective encrypted feature vectors, and return the identifier.

Still other aspects, examples, and advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by references signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 is a block diagram of a neural network construct coupled with a vector database configured to efficiently enroll and return a private identity, according to one embodiment;

FIG. 2 illustrates an example process for enrolling an identity, according to one embodiment;

FIG. 3 illustrates an example process for enrolling an identity, according to one embodiment;

FIG. 4 illustrates an example process prediction of an identify match, according to one embodiment;

FIG. 5 illustrates an example process prediction of an identify match, according to one embodiment; and

FIG. 6 is a block diagram of an example computer system that can be specially configured to execute the functions, algorithms, and/or operations disclosed herein to improve the computer system.

### DETAILED DESCRIPTION

According to some aspects, systems and methods for generating and returning fully private identification are provided. Various embodiments are configured to enroll and return identification results that operate with response times that are magnitudes faster relative to known private identity approaches (including for example, multiple model architectures having embedding and classifier models). According to one aspect, pre-trained neural networks can be configured to generate encoded identity information responsive to plaintext inputs. Various pre-trained networks can be used/trained on various identifying information inputs (e.g., facial image, retina scan, fingerprint, voice, behavior, gesture, etc.). In some embodiments, pre-trained networks are trained and used with a specific identification input to return optimal results. For example, a pre-trained network can be configured to process facial images that are provided as plaintext information. The system can invoke as many pre-trained face networks (or any other type) as needed to process input data. The pre-trained neural network can be configured to generate homomorphic encrypted feature vectors as an output, also referred to as embeddings.

According to various embodiments, vector databases can be used to store and retrieve the homomorphic encrypted feature vectors. The data itself can be optimized for storing and retrieving, and further vector indexes used for executing more efficient queries against the stored homomorphic encrypted feature vectors. As discussed, vector databases and vector indexes are optimized to manage vector data. These optimizations can yield architectures that emphasize computational efficiency over precision. In some settings, a query on the vector database of encoded identifiers can return results from multiple entities or multiple matching identifiers. Various embodiments are configured to incorporate additional review of query outputs from queries on the vector database to resolve any precision deficiency. For example, querying the database on a new embedding can result in multiple identifications being returned (e.g., matching on identity one, identity two, identity three, etc.). The inventors have realized that because the set of possible matches is a limited group, more computationally difficult operations can be executed on the limited group and used to resolve any precision issue while maintaining highly efficient execution overall.

According to one embodiment, a one-to-one match procedure can be used to determine if the new embedding (homomorphic encrypted feature vector) is a match for one stored in the vector database. Generally, a one-to-one matching procedure is inefficient over large data sets (e.g., each identification embedding would need to be checked on a one-to-one basis) and is too computationally burdensome to be used as an option in one-to-many matching scenarios expected in conventional settings. One-to-one matching offers high precision but at the cost of computational burden. When the vector query returns multiple matches (e.g., on the order 2-10 or on the order 10 s of matches), one-to-one analysis is viable in terms of processing time because of the limited group that must be analyzed. Further embodiments provide verification of returned matches, and still others also incorporate fast access data stores in conjunction with vector databases and/or vector indexes to provide additional processes for identification and/or authentication. Still other embodiments generate a centroid (e.g., k-mean value or other clustering value) for the embeddings of an enrolled entity and store the centroid value for subsequent matching operations. The use of the centroid can similarly return multiple matches, and the output verified using one-to-one comparisons.

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

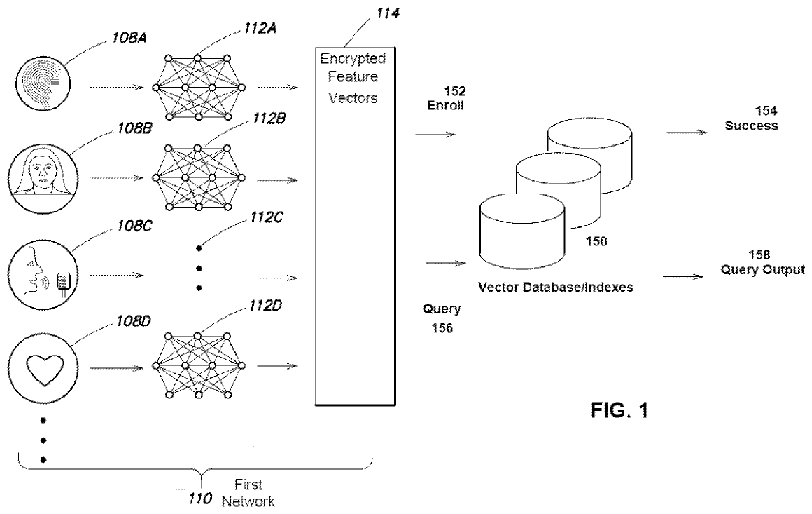

FIG. 1 illustrates a neural network/vector database architecture 100 configured to validate user identity while maintaining privacy of the underlying identifying information. According to various embodiments, a first neural network architecture (e.g., 112A-112D) is configured to generate homomorphic encrypted feature vectors also referred to as embeddings (e.g., 114) from a plaintext (unencrypted) input (108A-D) during processing by any or all of the first neural networks (e.g., at 110 first neural network processing). According to various embodiments, the first neural networks are pre-trained networks. In one example, the first networks can be pre-trained on a variety of identifying information, including for example, biometric and/or behavioral information. In some examples, a multitude of first networks are pre-trained with respect to types of input, where the information type can be based on a type of authentication input (e.g., biometric, fingerprint, facial image, voice sample, audio sample, biometric readings (e.g., heart rate, EEG scan, pulse, respiration, ambulation, etc.), as well as behavioral information, among other options). Other examples, are based on the entity to be identified and the identifying information capture and can include a similar approach to enroll and subsequently identify any signal, whether it is a face, voice, text, acoustic signature, radar signature, sonar signature, etc. Co-pending in commonly owned U.S. patent application Ser. No. 18/140,935 filed on Apr. 28, 2023 (Attn. Dckt. 00403.70003US02) and application Ser. No. 18/346,617 filed on Aug. 3, 2023 (Attn. Dckt. 00403.70005US02) describes various neural networks and examples of pre-trained networks used to support building user identities by producing encrypted feature vectors, which are incorporated by reference herein.

In some of the examples, described are neural networks configured to generate fully encrypted embeddings/fully encrypted feature vectors as outputs. The embeddings or feature vectors may also be described as homomorphic encodings of identity information as the encoding approach is configured to be one-way. One example of a first network includes the well-known FACENET implementation. While there are a variety of architectures for FACENET, the various architectures can be generalized as a convolutional neural network (“CNN”) having different architectures at the respective layers, including the use of different loss functions, initial weighting, among other options. In some embodiments, a traditional CNN is used to classify images (e.g., perform an identification function on the image), and a CNN architecture can be employed up until the classification stage or layer. In one example, the CNN processing is used up until the N−1 layer (N layer being classification), and produced embeddings are captured from the CNN, for example, for use with a vector database and/or vector index.

In various embodiments, the feature vectors can be stored in a vector database and/or included in a vector index at 150. In some alternative embodiments, a centroid can be computed via a k-means formula or other clustering technique, on a set of enrollment embeddings, and the centroid can be stored in the vector database for subsequent matching.

As storage to the vector database and/or index can include transformation into a lower dimension space, 150 can include operations to store the original embedding(s) separately (e.g., which can be encrypted via AES256, include salt values (e.g., time), among other options). According to one example, during enrollment at 152, a new identity is processed by the first neural networks to produce homomorphic encrypted feature vectors/embeddings. According to some embodiments, once embeddings are produced the original identifying information can be deleted to ensure privacy of the identifying information.

Various embodiments employ a vector database and vector indexes that are optimized to store vector data and may include metadata information about each embedding/vector (e.g., an identification label, watermark information, original embedding data, among other options). Vectors databases are optimized to manage traditional database operations and manage vector data. Thus, the addition of the embedding to the database is efficient and can occur in less than 10 ms, with various implementations averaging 2-4 ms. In some examples, the vector database can include an interface (e.g., an application programming interface (API)) that abstracts the database operation into traditional database functions (e.g., add, delete, modify, etc.) called via the API or in another example based on a software development kit (“SDK”). In some examples, successful operations can be reported via the API or SDK (at 154) or simply receive an acknowledgement or other communication to confirm.

In some examples, separate databases can be used: one to store the original embeddings used to enroll an entity, and the vector database and/or vector index used to perform matching operations. The database of original embeddings can be augmented with subsequently generated embeddings when a match is identified/verified. Further, the database of entity embeddings can be used to update centroid values by periodically recomputing a centroid value on the embeddings for an entity. The inventors have realized that identity information may change over time causing drift in enrollment information. For example, people change over time. According to some embodiments, the system is configured to keep all the embeddings, for example, in a mySQL database. Some embodiments keep enroll embeddings, and do not keep enroll+predict embeddings (e.g., generated during match operations)) as embeddings arrive over time. Other embodiments can use enroll and predict embeddings. This enables the system to recalculate each entity's centroid as it changes over time (e.g., as people age), allowing the system to adapt.

In some examples, the centroid can be computed on all the stored embeddings. In other embodiments, the centroid can be computed on a subset of embeddings (e.g., most recent, within a threshold period of time, based on a closest distance between embeddings (e.g., compared pairwise), etc. In further embodiments, lower dimension values can be determined and then a centroid can be computed on the lower dimension values. Additionally, various thresholds can be defined for re-calculation of centroid values. For example, it is recognized that such re-calculation can be important for children, where changes over a few years and sometimes even months can change the centroid. Still other embodiments can include a culling or reduction operation to archive older embeddings or limit data growth. In one example, embeddings that exceed a threshold distance from each other can be archived or removed from the dataset. In other examples, embedding having an age over a threshold value can be archived or removed. In some embodiments, the archival or removal operations can be used as an automatic trigger for a re-calculation of an entity's centroid.

According to various embodiments, a variety of embeddings and/or centroid value can be stored in the database and/or reflected in the indexes and linked to an identity. At query time (e.g., 156) a new embedding is generated by a respective first neural network (and associated plaintext identification input) and the embedding is used to build a query for the vector database. According to various embodiments, the vector database is configured to efficiently return similar embeddings in response to the query (e.g., at 158). In some examples, the vector databases can be organized according to an identification instance type (e.g., facial image source, fingerprint source, voice source, behavior information source, audio source, etc.), and metadata can be used to route a query to a respective database. In other embodiments, collections within a vector database can be organized based on information source and queries directed to respective collections. In another embodiment, pre-trained neural networks can be linked to respective vector databases and a query can be routed based on the neural network used to process a new identification input, among other options.

In some scenarios, the query output identifies a single identity which can be returned as the identification or as part of authentication, among other options. In some embodiments, the query output can be validated via a one-to-one matching operation. For example, the newly generated embedding can be compared directly to a stored embedding and/or centroid associated with the returned identity to verify the produced match. In other scenarios, the query output (e.g., at 158) can return similar embeddings associated with multiple identities. Embeddings associated with the multiple identities returned can be compared to the newly generated embedding using one-to-one comparison functions to resolve the ambiguity in the query results.

### Vector Database/Index Examples

Various embodiments use different vector database architectures and can also use vector indexes alone or in combination with the vector database. Vector databases are a specialized database designed to efficiently store and query vector data (e.g., embeddings). Vector databases are configured for optimized storage and querying capabilities for embeddings, addressing the limitations of traditional scalar-based databases and can even improve over standalone vector indexes.

Vector databases work by indexing vectors using algorithms like Random Projection, Product Quantization, Locality-Sensitive Hashing (LSH), or Hierarchical Navigable Small World (HNSW). The algorithms are configured to reduce high dimension data to a lower dimension space, while preserving the distinguishing characteristics of the original data. The algorithms allow for fast and accurate retrieval of similar vectors in large datasets. Similarity measures, such as Cosine Similarity or Euclidean Distance, can be used in comparing vectors and identifying relevant results for queries.

Vector databases also provide various features for efficient data management, metadata storage and filtering, scalability, real-time updates, backups, ecosystem integration, data security, and access control. They can include API access or and SDKs to simplify developer interactions and application integration, making them suitable for high-scale production environments.

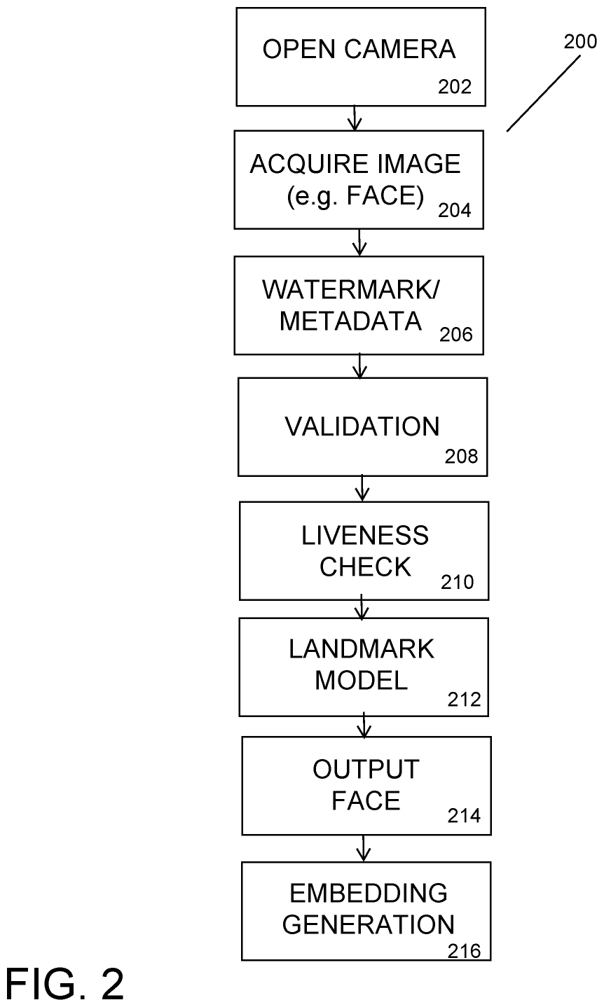

FIG. 2 illustrates a process flow for enrolling a user according to one embodiment. Process 200 is configured to enroll a user for subsequent identification and/or authentication based on facial image data. Other processes and/or pre-trained neural networks can be used in conjunction with other identifying information (e.g., other biometrics, health data, behavioral data, etc.), and executed as a similar process to 200 using respective neural networks.

According to one embodiment, process 200 can be executed on a mobile or other computing device that includes a camera. Process 200 begins at 202 with a request to open or access a camera resource. For example, javascript can be executed to open a camera, similarly web assembly can be executed to perform the same operation. Other options and other code can perform a camera access operation. At 204, the process continues with image acquisition.

According to some embodiments, the image acquisition can be executed in a JavaScript, web assembly, or other executable language or function request, among other options. At 206 the image is processed to include a security watermark and to define metadata associated with the image collection. In one example, the information and/or metadata can be stored in JSON format. JSON stands for Java script object notation a lightweight format for storing and communicating data. In further example, time of capture can be included in the watermark or metadata, and in still other examples, camera information or webcam driver information can be specified in the watermark or metadata (e.g., if the webcam driver is signed, that state is included in the watermark and/or metadata).

Process 200 can include operations to validate the specific identification instance. For example, process 200 can include validation functions at 208. According to one embodiment, the validation functions include operations to validate a proper face image has been provided. For example, the validation functions at 208 can be executed via a deep neural network (“DNN”). In other examples, multiple DNN's can be used to perform various validations. Process 200 can invoke any one or more or any combination of the following validations as part of 208: execute a three class YOLO DNN configured to check for eyeglasses, facemask, and presence of a normal face (e.g., normal detectable facial features); execute a two class YOLO DNN configured to test for an eyes open or eyes closed condition; a three class YOLO DNN configured to test a brightness condition in an image (e.g., too light, too dark, or normal); execute a three class YOLO DNN configured to identify hands, objects, or a normal image capture (e.g., to identify conditions where people enroll with hands or objects over parts of their face); execute blur analysis to detect excessive blurring or an unfocused state in an image (e.g., can be executed as procedural code); execute a landmark model configured to determine positioning thresholds within an image (e.g., 30 to 50 cm from camera-if camera is a WebCam, 20 to 40 cm from camera if image captured by a mobile device, left/right thresholds for validating the subject is looking straight into the camera, up/down thresholds to determine if the subject is looking straight into the camera and not up or down, test to validate eyes open, test to validate mouth is closed, and/or test to validate a head in the image is not in profile, among other options).

According to some embodiments, other network architectures can be used to validate the same conditions above and other intelligent models may also be used. As discussed, various embodiments may include any combination of the preceding validations or test conditions to facilitate proper enrollment. In further embodiment, various helper networks and/or functions can be used to ensure capture of “good” enrollment data or identification/authentication data for prediction. Examples of helper networks are described in commonly owned U.S. patent application Ser. No. 17/977,066 filed Oct. 31, 2022 (Attn. Dckt. No. 00403.70012US01) application Ser. No. 18/461,904 filed Sep. 6, 2023 (Dckt. No. 00403.70010US01), application Ser. No. 18/465,312 filed Sep. 12, 2023 (Dckt. No. 00403.70011US03) which are incorporated by reference herein.

According to some embodiments, process 200 may continue at 210 with a check for liveness. Liveness validation is configured to determine whether or not an identification instance has been presented by a live user or is not a fake or spoofed instance (e.g., static image positioned in front of the camera as opposed to a live capture of the subject's image). According to one embodiment, the system can execute a DNN configured to look for print paper textures, glass textures, or plastic textures as a way to identify a static image and fake identification presentation, among other characteristics of faked presentations. In one example, the DNN is configured to determine if a printed image is being used to spoof identification/authentication. The DNN can have many architectures, and in one example is based on a TensorflowLite implementation as a C++ dynamic library, compiled into a shareable object (.SO), which is wrapped in web assembly (“Wasm”). The check(s) for liveness at 210 may also include a digital spoof detection model. For example, a digital spoof detection model can be configured to look for phone or display screen textures (e.g., laptop or monitor, among other options).

Various models have been trained on spoofed images instances based on respective categories of spoof instance. The model can return a probability on the presence of spoof characteristics and/or on a probability that an image is a presentation attack for a given image input. In another example the digital spoof detection model can be configured to identify light or glare associated with any computer screen (e.g., laptop, mobile, monitor, etc.). According to one embodiment, the digital spoof detection model is a DNN exported from Tensorflow Lite as a C++ dynamic library, which is compiled into a shareable object (.SO) and wrapped into Wasm. According to another embodiment, the check for liveness at 210 may also include a phone detection model configured to look for a phone display screen or fingers wrapped around a phone screen. In one example, the model is a trained DNN exported from TensorFlow Lite as a C++ dynamic library, compiled into a shareable object (.SSO) and then recorded in Wasm.

According to one embodiment, process 200 can include validation functions specific to an identification instance (e.g., face image). According to some embodiments, process 200 can continue at 212 with execution of a face landmark model configured to identify a face within an image, return thresholds associated with the face within the image (e.g., left/right, up/down, among others, including, for example, distance from camera, etc.). According to one embodiment, the face landmark model can be implemented as a DNN. The DNN can be exported from TensorFlow Lite as a C++ dynamic library. The dynamic library can be compiled into a shareable object (.SO) wrapped into Wasm. In one example, the model is configured to find a face in an instance and return a bounding box for the face or a negative result (e.g.,-1). The model can return various thresholds (e.g., as discussed above) associated with the image and ultimately output a cut, cropped, and aligned face image at 214.

Once the aligned and cropped face image is returned the face image is used as an input into an embedding DNN at 216. The embedding DNN is configured to produce a fully encrypted homomorphic payload. The embedding DNN can be instantiated with a variety of architectures. In one embodiment, the embedding DNN is based on the FACENET architecture. Similar to other models, the embedding network can be exported from tensor flow light as a C++ library. The C++ library can be compiled into a shareable object (. SO) and wrapped into Wasm. In various embodiments, the embedding network receives a cut cropped and aligned facial image from the preceding steps and produces a fully encrypted homomorphic output. Commonly owned U.S. patent application Ser. No. 18/140,935 filed on Apr. 28, 2023) describes embedding networks with reference to embedding and feature vector generation, which applications are incorporated by reference herein.

In some embodiments process 200 continues at 218 with operations to add further encryption to the output of the embedding network. For example, at 218 the output can be encrypted using AES256 (or other encryption architecture) in conjunction with adding a time salt to the AES256 encrypted payload. The additional encryptions provide an extra layer of security over an already encrypted payload (produced as a one-way homomorphic encryption of an identification instance by the embedding network). The additional security improves over other conventional approaches by anticipating the potential suggested in some literature of training a DNN to reverse an embedding back to an original face image. Although the inventors believe such an approach would not function in the context of the embeddings produced herein, the additional security renders such an approach intractable/inoperable.

According to various embodiments, process 200 can be invoked or executed by the system to produce a fully encrypted feature vector/embedding. In addition, the fully encrypted feature vector/embedding can include additional encryption to protect against any opportunity to reverse the embedding to an original image. Other processes can follow the steps illustrated in process 200 with respect to other identification information (e.g., fingerprint image, retinal scan image, behavioral data, voice capture, health data, audio data, among other options).

In further embodiments, process 200 can be executed on a local device (e.g., possessed by a subject seeking to enroll). Local devices can be connected to a cloud-based enroll service that forms a part of the privacy preserving identification/authentication system. In other examples, a local device can be a computer system associated with the client of the privacy preserving identification/authentication system. The client can have local devices that are used to capture plaintext identification information and convert the plaintext identification instances through pre-trained embedding networks (e.g., via execution of processes (e.g., process 200) to produce fully homomorphic encrypted feature vectors/embeddings for a given identification instance (e.g., facial scan, fingerprint, retinal scan, behavior data, health data, etc.).

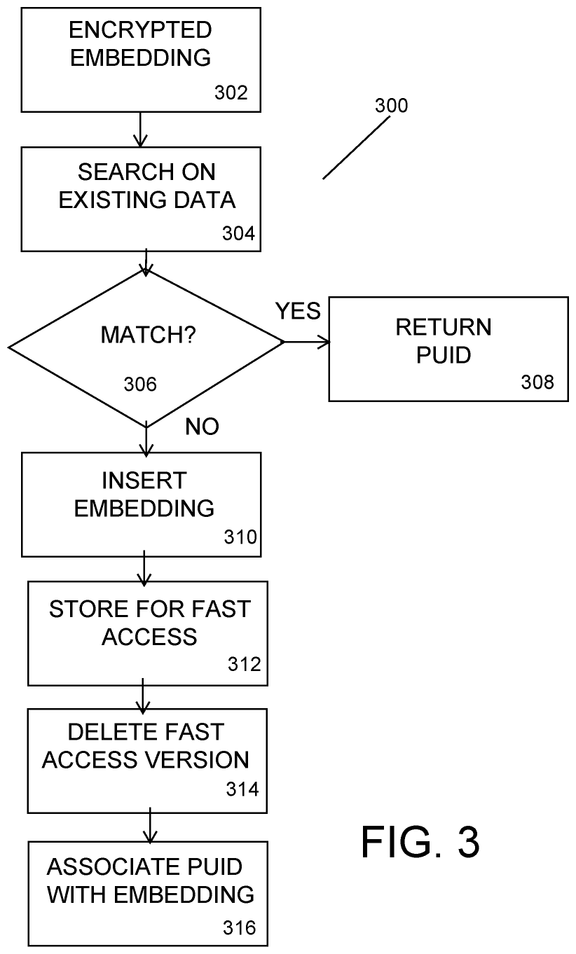

Shown in FIG. 3 is an example process flow 300 for enrolling a produced embedding/encrypted feature vector for use in a vector database. Process 300 can be executed by a cloud-based enroll service and/or architecture among other options. Process 300 begins at 302 with receipt or communication of an encrypted embedding. For example, the encrypted embedding can be received at a server system that hosts the cloud-based enroll service. Communication security can be used in addition to the security features described above (for example with respect to process 200). For example, the communication can include the fully homomorphic encrypted embedding combined with AES 256 encryption and TLS (transport layer security). Once received, process 300 continues at 304 with a search through any existing embeddings to ensure that the enrollment embedding is new (e.g., not already enrolled).

According to one embodiment, the system can include a Vertex AI matching engine. The Vertex AI matching engine is configured to provide a vector database service. In this context, the Vertex AI matching engine is used to store and query vector-based embeddings. Other implementation can use different vector database offerings and/or implementation. Various embodiments, employ the Milvus vector database as a platform, and various example considerations are discussed in greater detail below. According to one embodiment, the Vector AI matching engine provides database management service (DBMS) tailored to vector-based data. The engine finds the most similar items (e.g., embeddings) for a given query and can do so for a large corpus of embeddings efficiently. The matching engine is configured to search for similar or related items and in this case fully encrypted homomorphic embeddings. In some examples, the vector database is specifically optimized to perform nearest neighbor searches on stored embeddings responsive to a submitted query vector (e.g., generated from a new embedding). In further embodiments where a centroid is used, the vector database is specifically optimized to perform, for example, nearest neighbor searches on stored centroids responsive to a submitted query vector (e.g., generated from a new embedding)

According to one embodiment, step 304 can include a call to a predict service that is configured to identify any matches between an incoming embedding and a stored embedding and/or centroid (e.g., via the vector database and similarity matching or approximate nearest neighbor searches, among other options used in vector databases and/or vector indexes). If there is a match to an existing embedding/centroid, at 306 yes, the identifier associated with the existing embedding/centroid is returned and process 300 stops at 308. If the new embedding is not already enrolled, at 306 no, then process 300 continues at 310 with an operation to insert the communicated embedding into the vector database (e.g., Vertex AI matching engine/vector database). According to some embodiments, the original embedding (e.g., produced by process 200) can be stored in its original form in the vector database or may be stored separately in another database instance (e.g., SQL, scalar, vector, etc.). In other examples, identification of a new/unenrolled embedding can be used as a trigger to computation of a centroid for a new entity, and the centroid used in place of multiple embeddings.

Addition of new embeddings to a vector database can include re-indexing of the database to optimize query performance. Reindexing of the database is typically a time-consuming operation (e.g., on the order of 30 or 40 minutes) or computationally burdensome. Various embodiments can include a faster verification service that may be invoked during the re-indexing operation. According to one embodiment process 300 can continue at 312 during the re-indexing time with an insertion of the communicated embedding into a server memory location. The server memory location is configured to allow the cloud-based service to authenticate a new user immediately based on a check of the server memory location (e.g., via similar search, distance metrics, nearest neighbor search, etc.). In one example, the server memory location can be implemented as a REDIS object that can be used in conjunction with the vector database query approach, and that provides a verification service having a shorter update period during re-indexing operations. In other embodiments, the system may also provide for multi-network identification (e.g., embedding networks and classifier networks trained on the embeddings or centroids of the embeddings).

In other embodiments, the vector database management functions can limit the impact of indexing/re-indexing vector data by breaking a collection of vector data into smaller units or “pods.” Re-indexing portioned vector data, including, for example a most recent pod (likely to have the smallest volume of vector data) can proceed more efficiently.

Commonly owned co-pending U.S. patent application Ser. No. 17/628,081 filed on Feb. 28, 2022 (Attn. Dckt. No. 00403.70007US01) describes examples of fast identification architectures (including, for example, Frobenius stores) that enable use of new embedding information quickly as slower processes complete updates, incorporated by reference herein. Various embodiments use of quickly available verification stores in conjunction with vector databases. Incorporated material also describes classification networks that can also be used to generate matches to identity by training classifier networks on embeddings. The classifier networks can be augmented via training on centroid values to improve their accuracy and efficiency. In some embodiments, the classifier networks can be used to provide a fast query option where the population of enrolled entities is large (e.g., >40, >50, >100, >150, etc.). In still others combinations of REDIS and classifier networks can be used in conjunction, and availability and efficiency can be used to manage selection between the options.

According to some embodiments process 300 can continue at 314 once reindexing has completed with the deletion of any embeddings in the REDIS storage location. In further embodiments, process 300 can also monitor the size of the REDIS storage location and when it exceeds a threshold (not shown), trigger a re-indexing of any associated vector database. The re-indexing operation can be configured to result in deletion of any embeddings in the REDIS storage location (e.g., at 314). If the threshold is not exceeded, the monitoring may continue.

At 316, responsive to adding an embedding to the vector database a new identifier can be associated to the newly enrolled embedding. According to some embodiments, the new identifier can be a PUID (persistent unique identifier). In other embodiments, the identifier can also be a universal unique identifier (e.g., UUID), such as those discussed in commonly owned co-pending U.S. patent application Ser. No. 17/583,687 filed on Jan. 25, 2022 (Attn. Dckt. No. 00403.700013US00), which is incorporated by reference herein. The UUIDs discussed are recoverable with an embedding network and a classifier network. Various embodiments herein recover or link UUIDs via an embedding network and a vector database and/or vector index. An identity can be generated when storing an embedding at 318 and linking that embedding to a PUID. Once a new identifier is created and associated with a stored embedding, process 300 can return the new identifier to acknowledge the successful enroll. Additional acknowledgments or success messages may also be communicated.

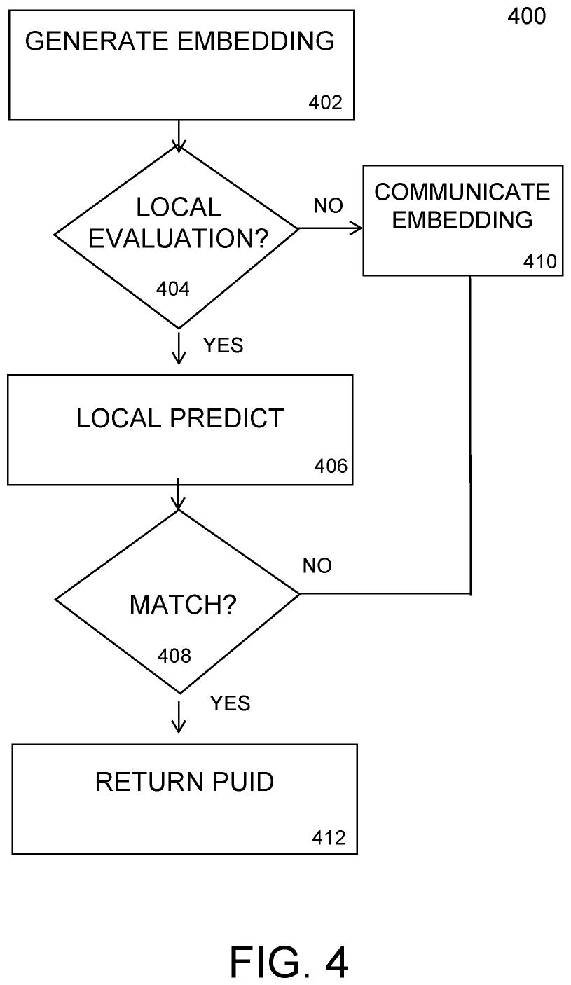

According to some embodiments, process 200 and process 300 can be used to generate a new identity and associate the identity with one or more embeddings. Once an identity has been established, the corresponding entity can request identification and or authentication at a subsequent time. The matching process between a newly submitted embedding and a stored embedding can be referred to as prediction. The prediction process can be executed similarly to process 200 and 300, except the goal is to match a newly submitted embedding to a stored one. FIG. 4 illustrates an example process 400 for generating a prediction on a submitted identification instance. Process 400 begins at step 402 with generation of an embedding from a plaintext identification instance. For example, step 402 can include the functions described with respect to process 200 and 300. In one embodiment, the steps in process 200 can be repeated as can the steps in process 300 up until and including step 308 where an existing enrollment is detected.

Once an embedding has been generated, process 400 can execute a prediction or attempt to match the target embedding to a stored embedding. In some examples, a local database can be available on a local system (e.g., the system on which the embedding has been generated from a plaintext identification instance capture). For example, process 400 can include a step 404 (e.g., local yes). When a local predict is being executed (404 yes), different accuracy thresholds can be used relative to a remote matching process. For example, an identification/authentication system can leverage the knowledge that a local verification is generally requested for a person that has already used the local device. In some embodiments, the system and/or process can leverage that understanding and employ a looser verification threshold. In some scenarios, this translates into the ability of an entity (e.g., user) to be wearing eyeglasses or personal protective equipment (“PPE”) during identification/authentication (as opposed to during enrollment wherein some examples would invalidate submission for enrollment). In other embodiments, a local store of embedding information is not available (404 no) and process 400 proceeds to 410 with communication of a generated embedding to a cloud-based or remote service.

In some embodiments, a local predict can also operate differently than a remote prediction. For example, at 406 a linear scan can be executed to compare a new target embedding to every embedding in a local store of embeddings. In other examples, the scan can be made against a centroid value. The local store can be in a variety of formats (e.g., relational database, NoSQL database, SQL database, vector database, among other options). In some examples, a limit to the size of the local store can be imposed. Optional steps can be executed as part of process 400 to monitor the size of the local store and ensure that it does not exceed a threshold. The threshold can be used to define a threshold number of identities that are stored or used for prediction, among other options (e.g., size threshold, etc.). In one example, a forty person/identity threshold can be used to limit the size of the local store. Other example thresholds for a number of identities can be used—10, 15, 20, 25, 30, 35, 40, etc.

In some embodiments, the linear scan at 406 can include a number of operations. The operations can specify; decrypt a target embedding, decrypt a first embedding or centroid from the local store, compare target embedding to the stored embedding, if a true match is determined, return the PUID associated with the matched embedding in storage, if no match is determined, continue the decrypt and compare operations for each embedding in the local store, if no match is determined for any stored embedding (408, no), communicate the target embedding in encrypted form (embedding, plus AES256 with salt, plus TLS) to a remote or cloud-based prediction service (e.g., at 410). If a local match occurs, the PUID associated with the matched embedding can be returned at 412.

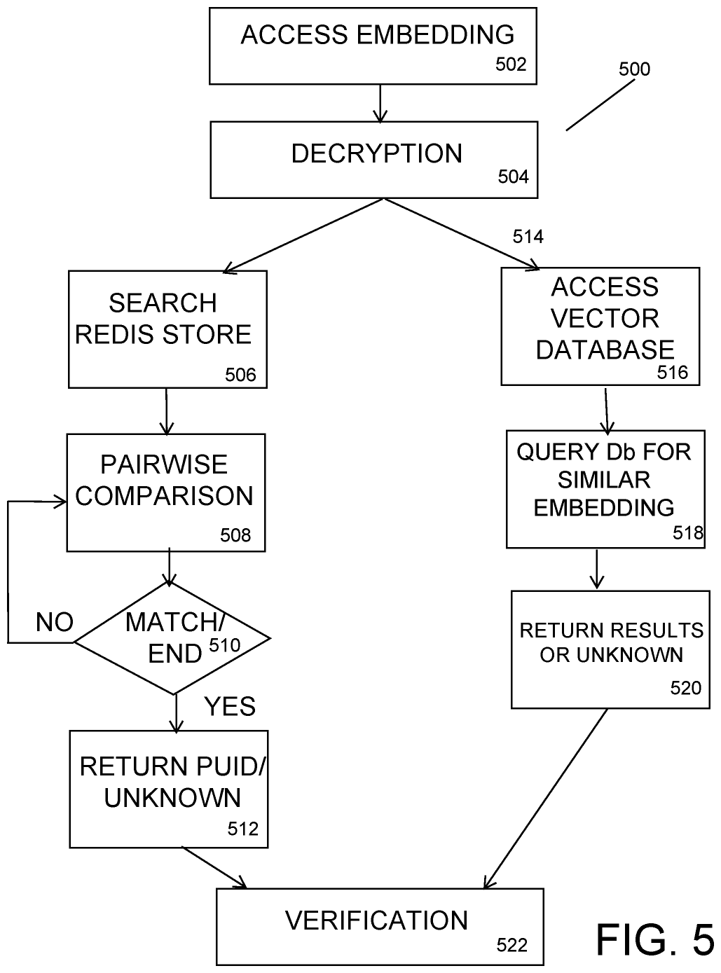

FIG. 5 illustrates an example process flow 500 for executing a remote or cloud-based prediction service. Process 500 begins at 502 with receipt of an encrypted embedding. Process 500 continues at 504 with the decryption of any transport layer security, and can include decryption of the AES 256 encoding (and any time salt). In some embodiments process 500 can continue with multiple threads: one thread to search for any embedding in the REDIS data, and one thread to search a vector database (e.g., via the VertexAI matching engine and/or any vector database/vector indices). According to one embodiment, process 500 executes one thread at 506 with a linear scan of the REDIS store. The linear scan at 506 can include operations to decrypt the target embedding (if not already decrypted), decrypt a first embedding from the REDIS store (if not already decrypted), compare target and stored embedding (e.g., at 508), if a true match is determined (510 yes) return the PUID associated with the stored embedding (512), where no match is determined (508 no) continue any necessary decryption and further pairwise comparison (508) with each stored embedding until a match is returned (508 yes-510) or the entire data store is reviewed (508 Match end) and an unknown result is returned (512). In some embodiments, the scan of the REDIS store returns multiple matches (e.g., more than one embedding is stored for an identity). The best match can be returned, where the best match is determined based on distance or closest similarity to the target embedding. In some examples, the REDIS approach can be used until a threshold number of embeddings are captured for an entity/identity. The threshold number can be used to manage computation of a centroid and its addition to a vector database/index, among other options.

Process 500 can include a second thread at 514 configured to access a vector database to return any matching embeddings. As part of execution of process 500, a vector database and/or vector index is accessed at 516 (e.g., Vertex AI matching engine), which will return similar embeddings based on executing a query using a query vector generated from a target embedding (that was just received). In some embodiments, the vector database and/or vector index will return a number of matches that are similar to the target embedding. It is realized that while vector databases and/or vector indexes are efficient at identifying and returning query responses, the precision of such approaches is reduced to achieve the efficiency. In many vector databases, a high dimension vector is reduced to a lower-dimensional space (e.g., via a random projection matrix, product quantization, locality-sensitive hashing, etc.). The reduction in dimension space enables efficiency in storage and querying but results in a loss of precision. Most reductions to the lower dimension space are lossy or approximate.

According to one embodiment, process 500 can continue at 520 to provide any returned results from the query operation. In one example, the vector database and/or vector indexes are configured to return a threshold number of embeddings (or centroid values) that are similar to the target embedding. The threshold number of embeddings that are returned is a tunable parameter, and can be varied based on the number of embeddings that are stored in the database. The inventors have determined that as the number of embeddings increases in the vector database the accuracy/precision of the query can be reduced.

According to one embodiment, the system and/or process can be configured to increase the threshold, so more results are returned as more users are enrolled and the vector database/vector indices increase in size. According to one embodiment, the vector database/indexes are configured to return a number of results that are rank ordered based on similarity to the query vector (e.g., the target embedding). Step 520 can include returning the best possible match (e.g., highest rank order result), and can also include a linear scan of the returned results against the target embedding to return any match from the threshold number of results/matches. For example, the threshold number of matches may include multiple identities. The original stored embeddings for each of the multiple identities can be retrieved from the database, and compared directly to the target embedding to determine which match is the best/correct (e.g., in terms of distance evaluation, cosine evaluation, etc.).

Process 500 may also include a verification step at 522. For example, process 500 can include a step to evaluate any results returned from either thread. For example, the results returned from the vector database/indexes and/or any result returned from the REDIS Store, can be verified. According to one embodiment, the verification can be based on retrieving an original embedding associated with a returned PUID and a direct comparison of the original embedding to the target embedding (e.g., received or accessed at 502). The direct comparison can be based on a distance evaluation to ensure that the output results are correct by evaluating whether the target embedding matches the stored embedding for a predicted identity. In one example, the verification requires that the stored embedding be within a threshold distance from the target embedding (e.g., Euclidean distance <0.8 or unknown) to verify a match. In some scenarios, the result is an unknown embedding, which can be used by an identification/authentication system to add the embedding and create a new identity (e.g., PUID).

Optionally, identification or authentication based on matching an embedding to a vector database (or REDIS store) can be used as a portion of a valid identification or authentication. For some systems and/or actions, additional security may be required. Additional security measures can be used to increase the likelihood of a valid identification or authentication. For example, identification or authentication can include any one or more of the following, check for: a passkey, verified credentials, PIN, password, or barcode on driver's license to increase the confidence level of the identification or authentication.

Additional steps can be executed in response to a verified match. For example, if an identity (e.g., user) is not saved in a local store, then process 500 can include an optional step to update the local store. For example, the process can save AES256+encrypted embedding+PUID in a database (e.g., SQLite) running in a browser local store, among other options.

According to various embodiments, a unique and arbitrary label can be used to define an identity for an entity, user, etc. The identity can be linked to corresponding embeddings. For example, even where the entity/actor is unknown, the identity can link any embeddings input to the arbitrary label, enabling identification of users (even unknown) and their respective activity. In some embodiments, a central component or central remote server functions to assign universal identifiers for use as labels. In some embodiments, the remote server can be configured to manage and reconcile universal user identifiers (UUIDs) across any connected devices. In still other embodiments, the remote server can be configured to manage embedding/identifier linkages even across various security platforms that maintain their own linkage between a UUID and underlying identities. In further embodiments, these identifiers can be combined with other values to define authentication environments or silos. For example, encryption keys (e.g., API keys) can be linked to the identity and/or combined into a unique identity allowing various identifiers to be tailored and used in specific identification environments, applications, within organizations, etc.

In some embodiments, the respective user does not need to be known at all, and still any activity on a device can be linked to a respective label with confidence and/or a validated identity. In further embodiments, the UUID is maintained as an anonymous identifier and encrypted embeddings can be used by a server or remote systems to merge activity and identifications across any number of devices. Additional examples are described in the incorporated material for implementation of a UUID, and the implementation described can be modified to use vector database queries instead of classification neural networks to improve execution and efficiency over embedding/classifier architectures.

According to various embodiments, plaintext identification information (e.g., behavioral, biometric, physiologic, and/or digital activity based information, among other options) can be processed by helper networks that are configured to protect embedding networks that generate encrypted features vectors. In various settings, helper networks protect embedding networks by ensuring that only good identification data is used to construct encrypted feature vectors used in subsequent identification/authentication.

According to various embodiments, helper networks are configured to recognize good identification data and/or recognize bad identification data, where good identification data improves the identification entropy of the resulting feature vectors when used to train classification networks. For example, helper networks are configured to identify spoofed identification data. Spoofed identification can include captured video of a subject replayed for facial recognition or a captured photo represented for facial recognition. Various example helper networks are configured to recognize presentation attacks in various forms. From a high level perspective, when bad identification data is used to build encrypted feature vectors and in subsequent identification/authentication, the accuracy of the entire system is reduced. Thus, filtering bad data from subsequent use protects the identification system and yields improved accuracy. Other examples of bad data include blurry images, poorly cropped images, multiple indistinct subjects in a sample, bad audio capture, too much noise, among many other options. Helper networks are trained on good and bad data samples to validate good samples and filter bad samples.

According to other embodiments, liveness can be validated with capture of identification information by helper networks. Liveness describes the condition to test whether the user has actually submitted the identification information being processed, and also to ensure submission occurs contemporaneously with the request/submission of identification information. In various embodiments, bad identification data can be filtered before the identification information is used for generating encrypted feature vectors. In other embodiments, good identification data can be validated to produce filtered plaintext identification information. By filtering and/or validating the plaintext identification information, the accuracy and durability of the embedding networks is preserved.

According to another embodiment, once secure and private identification is enabled by the system, various architectures extend the identification capability into analysis across a variety of devices and seemingly disparate actions and/or activity. Various architectures can include local and remote components of a private identity system. Local in this context can be based on being at or proximate to a device where plaintext identifying information is being captured for identification. According to one embodiment, an identification system integrates local identification functions and remote identification functions to establish a private identity system. According to some embodiments, each of the identification functions (local and remote) can be used to establish, train, and/or update neural networks that are configured to generate private identification. The neural networks can then be synchronized in the local and remote settings. In some embodiments, new labels and/or encrypted feature vectors can be communicated from local to remote and vice versa allowing vector databases to be updated and to integrate new labels (e.g., identities). In some alternatives, a “new” local label and embeddings can be communicated to the remote server 351, which identifies an existing match to the same embeddings. In this example, the labels are reconciled (e.g., 362-merged label, retrain network, link label, or distribute classification network with exiting label, index or re-index vector database, etc.) across the system and the networks updated accordingly.

For example, encrypted embeddings can be created on an “unknown” actor. In the local setting, the unknown actor can be added with a unique activity label, so that all actions by the same actor (who may remain anonymous) on that device can be identified as being done by that actor. For spam or phishing activity, this is a powerful tool as the actor will be identified, for example, by voice regardless of what contact information changes from time to time or attempt to attempt. For example, the remote identification services can use the various identifications produced locally at a multitude of devices to define neural networks on a multitude of users, and multitudes of activity identities. Likewise, an actor who the device owner interacts with regularly (but has no contact information), can still be identified as a known entity or actor based on matching embeddings. The same activity actor can be identified by their private biometrics (e.g., encrypted embeddings) even where that entity or actor is connecting with the device owner from a different unknown phone number or when using a known phone number belonging to someone else. In yet another example, the system can still identify that actor when their originating device is actively blocking identification information because, for example, they leave a voice message, and the system creates encrypted feature vectors from the recording and matches those encrypted feature vectors to stored embeddings in a vector database.

According to some embodiments, the local devices are configured with neural networks that perform identification based on executing neural networks. Local identification can be executed to identify a user of a given device with one or more neural networks executing at the device. Each entity who uses the device can be identified with the local identification functions that have helper networks to ensure good identification data is used, embedding networks that are configured to generate encrypted feature vectors/embeddings from the identification data, and vector database(s) that match the embeddings to identities. For example, a camera on the device captures plaintext facial information (e.g., face image). The helper networks can ensure that the image capture generates a good information sample of the face image, which is then communicated to the embedding networks that produce encrypted feature vectors for use in vector queries or storage in a vector database. Typically, the plaintext data is deleted upon creation of the encrypted feature vectors preserving privacy.

As the entities using the device change, the device can be configured to provide different operations, levels of access, etc., which can be tailored to the respective user identified by the private identity functions. In one example, an administrative user can be given the authority to define what functions a group of users are given access to, including the ability to assign or remove functionality for various user/identities. Each time new identification samples are detected on the device (e.g., new user of the device and/or new activity on the device), the local identification functions will attempt to identify the new user (which can include continuously verifying the identity of the current user) and/or various activity monitors will review digital activity on the device and attempt identification of the actor associated with the digital activity.

A local activity monitor can be executed on the device to detect digital activity. The activity monitor is configured to access new activity and use the new activity as input into the local identification functions. In one example, a new voice message may be received on the device, and the activity monitor can process the received message as an audio input to an audio helper network that validates a good identification sample (e.g., voice recording). The validated audio can then be processed by an audio embedding network to produce encrypted feature vectors, which can be used to identify an actor associated with the audio by using a vector database. In another example, an active phone call can be identified and processed through the identification functions. In one embodiment, the activity monitor is configured to capture voice information from an active phone call to generate an identification of the speaker (or even speakers in a conference call). In another embodiment, the activity monitor is configured to identify a voice conference, capture video, images, and/or audio for processing by the identification functions.

In various embodiments, the identification system can be used to identify actors or entities associated with various digital activity, in this example, to identify a source entity for the voice message. Other activity including video chat, Zoom meetings, twitch streams, etc., can be processed by activity monitors, which can confirm the identity of each actor within the content. While the actor as a source can be identified, the system can also operate where the identity information for the actor is unknown, and the system matches the voice to a unique and/or anonymous label. In various embodiments, additional processing may be done to build or associate information on the underlying actor or entity. In the voice message context, transcription of the voice message may identify the caller—“Hi, its Mike . . . ”. That information can be associated with the label and encrypted feature vectors, but may require confirmation. In another example, for a voice conference, calendaring information may be captured and linked to an identity profile. Further, the system can identify and flag instances where the same voice uses different identifying information as suspect, or potential fraud. When this identifying capability is extended via the remote identification services, the ability to identify an actor (even if anonymous) is multiplied by each and every connected device as the various helper, embedding, and vector databases are updated.

### Example Vector Database Implementation

Some embodiments employ the known Milvus vector database. In such settings, assume 100 million 512-dimensional vectors and a need to insert and manage them in Milvus sourced database. According to one embodiment, vector insert is managed to achieve efficient storage and query operation. As 512-dimensioned vector would take roughly 2 KB space, the minimum storage space for 100 million vectors is about 200 GB, which makes one-time insertion of all these vectors unrealistic. In some embodiments, the vector database is configured to employ multiple data files instead of one. A Milvus sourced database supports one-time insertion of hundreds or even tens of thousands of vectors. For example, one-time insertion of 30 thousand 512-dimensional vectors generally takes only 1 second. In some examples, the database manages multiple storage units for vectors to enable insert efficiency, and each unit can be broken down into a mutable and immutable buffer on the CPU. For example, not every vector insertion is loaded into disk. By reserving a mutable buffer in the CPU memory for every table that is created, inserted data can be quickly written. And as the data in the mutable buffer reaches a certain size, this space will then be re-labeled as immutable, and a new mutable buffer will be reserved. Data in immutable buffer is written to disk regularly and corresponding CPU memory is freed up.

When vectors are written to disk, they are saved in a raw data file containing the raw vectors. As mentioned before, massive-scale vectors need to be saved and managed in multiple data files. Inserted data size varies as users can insert 10 vectors, or 1 million vectors at one time. However, the operation of writing to disk is executed periodically (e.g., every 1, 2, 3, 3, or 5 seconds, among other options). The result is that data files of different sizes are generated.

Background processes can be executed to merges these small data files until the merged file size reaches a particular size, for example, 1 GB. This particular size can be tailored and an API parameter index_file_size can be set as part of table creation. Based on the assumed values and a 1 GB size parameter, 100 million 512-dimensional vectors will be distributed and saved in about 200 data files. The small data can be accessed and searched prior to merge. Once the merge is completed, the small data files will be removed, and newly merged files will be used for search instead.

A search can be done on the raw data and is a brute-force search which compares the distances between query vectors and origin vectors, which computes, for example, the nearest k vectors. Brute-force search is inefficient. Search efficiency can be greatly increased with an index file where vectors are indexed. Building the index requires additional disk space and can be time-consuming. Raw Data File records every single vector together with an associated unique ID, while an index file records vector clustering results such as index type, cluster centroids (e.g., central vector), and vectors in each cluster.

In one example, an index file contains more information than raw data file, yet the file sizes are much smaller as vectors can be simplified and/or quantized during the index building process (for certain index types).

Newly created tables can be searched by brute-computation by default. Once the index is created in the system, the index search can be used. Indexes are automatically built for merged files that reach the specified size limit (e.g., 1 GB) in a standalone thread. When the index building is completed, a new index file is generated. The raw data files can be archived for index building.

In an example, 100 million 512-dimensional vectors are saved in 200 disk files. When index is built for these vectors, the result is 200 additional index files. Metadata solutions can employ OLTP databases to manage these files and associated information (e.g., metadata can include name of the table the file belongs to (table_id), index type of the file (engine_type), file name (file_id), file type (file_type), file size (file_size), number of rows (row_count) and file creation date (created_on), among other options). Some implementations can include a query scheduler to optimize hardware utilization and improve efficiency.

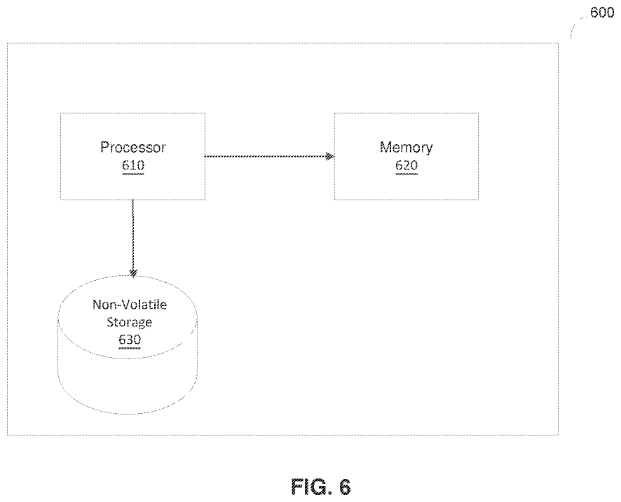

Modifications and variations of the discussed embodiments will be apparent to those of ordinary skill in the art and all such modifications and variations are included within the scope of the appended claims. An illustrative implementation of a computer system 600 that may be used in connection with any of the embodiments of the disclosure provided herein is shown in FIG. 6. The computer system 600 may include one or more processors 610 and one or more articles of manufacture that comprise non-transitory computer-readable storage media (e.g., memory 620 and one or more non-volatile storage media 630). The processor 610 may control writing data to and reading data from the memory 620 and the non-volatile storage device 630 in any suitable manner. To perform any of the functionality described herein, the processor 610 may execute one or more processor-executable instructions stored in one or more non-transitory computer-readable storage media (e.g., the memory 620), which may serve as non-transitory computer-readable storage media storing processor-executable instructions for execution by the processor 610. The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples (e.g., the processes described above, etc.) have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A private identity system, the system comprising:
at least one processor operatively connected to a memory, the at least one processor configured to:
instantiate at least one pre-trained embedding network configured to generate encrypted feature vectors from an input of plaintext identifying information;
process an input of plaintext identifying information using the at least one pre-trained embedding network;
generate a target encrypted feature vector for enrollment; and
store a representation of the respective encrypted feature vector in a vector database or vector index for subsequent prediction.

2. The system of claim 1, wherein the at least one processor is configured to validate submission of the plaintext identifying information.

3. The system of claim 1, wherein the at least one processor is configured to validate data captured in the plaintext identifying information.

4. The system of claim 1, wherein the at least one processor is configured to pre-process the data captured in the plaintext identifying information.

5. The system of claim 1, wherein the at least one processor is configured to store the target encrypted feature vector.

6. The system of claim 1, wherein the at least one processor is configured to associate an identifier with the representation of the respective encrypted feature vector.

7. The system of claim 1, wherein the representation of the respective encrypted feature vector is a lower dimension representation of the respective encrypted feature vector.

8. The system of claim 1, wherein the representation of the respective encrypted feature vector is a centroid value computed from a set of encrypted feature vectors associated with an entity.

9. The system of claim 8, wherein the at least one processor is configured to:
generate a prediction encrypted feature vector for prediction from an input of plaintext identifying information; and
query the vector database or vector index to match in a first pass on a respective centroid value.

10. The system of claim 7, wherein the at least one processor is configured to return at least one similar representation of a plurality of encrypted feature vectors stored in the vector database or vector index.

11. The system of claim 10, wherein the at least one processor is configured to retrieve a plurality of respective encrypted feature vectors associated with the plurality of identifiers.

12. The system of claim 11, wherein the at least one processor is configured to compare the plurality of respective encrypted feature vectors to the prediction encrypted feature vector to determine a best match or verify a match.

13. The system of claim 1, wherein the at least one processor is configured to generate a centroid value for a plurality of encrypted feature vectors associated with an entity; and store the centroid value in a vector database or vector index for subsequent prediction.

14. A method for enabling private identity, the method comprising:
instantiating, by at least one processor, at least one pre-trained embedding network configured to generate encrypted feature vectors from an input of plaintext identifying information;
processing, by the at least one processor, an input of plaintext identifying information using the at least one pre-trained embedding network;
generating, by the at least one processor, a target encrypted feature vector for enrollment; and
storing, by the at least one processor, a representation of the respective encrypted feature vector in a vector database or vector index for subsequent prediction

15. The method of claim 14, wherein the method further comprises validating submission of the plaintext identifying information.

16. The method of claim 14, wherein the method further comprises pre-processing the data captured in the plaintext identifying information.

17. The method of claim 14, wherein the method further comprises storing the target encrypted feature vector.

18. The method of claim 14, wherein the method further comprises associating an identifier with the representation of the respective encrypted feature vector.

19. The method of claim 14, wherein the representation of the respective encrypted feature vector is a lower dimension representation of the respective encrypted feature vector.

20. The system of claim 14, wherein the representation of the respective encrypted feature vector is a centroid value computed from a set of encrypted feature vectors associated with an entity.
